(19) United States
(12) Patent Application Publication
(10) Pub. No.: US 2015/0206108 A1
(43) Pub. Date: Jul. 23, 2015

(54) SOCIAL DONATION SYSTEM

(71) Applicant: Centscere LLC, Syracuse, NY (US)

(72) Inventors: Franklin Taylor, Norwich, VT (US); Ian Dickerson, Coto de Caza, CA (US); Michael Smith, Paramus, NJ (US); Stephen Shaffer, Ithaca, NY (US)

(73) Assignee: CENTSCERE LLC, Syracuse, NY (US)

(21) Appl. No.: 14/161,342

(22) Filed: Jan. 22, 2014

(51) Int. Cl. G06Q 20/10; G06Q 50/00

(52) U.S. Cl. CPC G06Q 20/10; G06Q 50/01

(57) ABSTRACT

A system and method for transferring funds to an entity. The system includes computer code for performing and the method follows the steps of: identifying an action on a social networking site, predetermined to represent a command to transfer funds to an entity; retrieving previously stored information identifying at least one payment account associated with the user; retrieving previously stored information identifying at least one payment account associated with the entity; and transferring the funds from the payment associated with the user to the payment account associated with the entity.

### FIELD OF THE DISCLOSURE

The present disclosure relates to micro-level donations generally, and particularly to micro-level donations transacted over social networking.

### BACKGROUND

Micro-donations play an increasingly important role in charitable contributions. Previous micro-donation systems have allowed donations online and over mobile devices, however, social networking has remained a largely untapped resource for micro-donations. Facebook alone contains over 1.19 billion active users, and that number is growing everyday. With such a large user-base, and a lack of a social network micro-donation platform, there exists a need in the art for quick, efficient method to donations over social networking.

### BRIEF SUMMARY

These and other objects and advantages are accomplished by a method for transferring funds to an entity, comprising the steps: identifying an action on a social networking site, predetermined to represent a command to transfer funds to an entity; retrieving previously stored information identifying at least one payment account associated with the user; retrieving previously stored information identifying at least one payment account associated with the entity; and transferring the funds from the payment associated with the user to the payment account associated with the entity.

In accordance with another embodiment, a method further comprising the step of retrieving previously stored information identifying the amount of funds to be transferred upon identifying the user action.

According to another aspect, the method wherein the action is performed by the user.

According to another aspect, the method wherein the action is performed by the entity.

According to another aspect, the method further comprising the steps of: retrieving previously stored data identifying a donation condition; checking whether the donation conditions has been met; preventing the transfer if the donation condition has not been met.

According to another aspect, the method wherein the donation condition is a maximum donation limit within a predetermined period of time.

According to another aspect the method wherein the donation condition is a type of entity.

According to another aspect, the method further comprising the step of posting to a predetermined social network the entities to which the user has donated.

According to another aspect, the method wherein the step of transferring comprises: deducting the funds from the payment account; depositing the funds into an escrow account; deducting the funds from the escrow account; and depositing the funds into the payment account associated with the entity.

According to an aspect, the method wherein the step of deducting funds from the user's payment account occurs at a predetermined time.

According to an aspect, the method wherein the step of transferring to the entity occurs at a predetermined time.

In accordance with another embodiment, a server system for transferring funds to an entity, comprising: a data storage medium storing data for at least one user and at least one entity; a monitoring component for identifying at least one action on a social networking site, predetermined to represent a command to transfer funds to the at least one entity; a transferring component that, upon identifying the user action, retrieves from the data storage medium data representing a payment account associated with the user, and data representing a payment account associated with the entity, and that transfers funds from the user's payment account to the entity's payment account.

According to an aspect, the system, wherein the transferring component retrieves the amount to be transferred from the data storage medium.

According to an aspect, the system wherein the action is performed by the user.

According to an aspect, the system wherein the action is performed by the entity.

According to an aspect, the system further comprising: a comparator component that retrieves from the data storage medium data representing a donation condition, that checks whether the donation condition has been met, and that prevents the transfer of funds if said condition has not been met.

According to an aspect, the system wherein the donation condition is a maximum donation limit within a predetermined period of time.

According to an aspect, the system wherein said donation condition is a type of entity.

According to an aspect, the system further comprising a posting component for posting to a predetermined social network the entities to which the user has donated.

According to an aspect, the system wherein the transferring component first transfers the funds to an escrow account and then transfers the funds to the entity.

According to an aspect, the system wherein the transferring component transfers the funds from the user's payment account to the escrow at a predetermined time.

According to an aspect, the system wherein the transferring component transfers the funds from the escrow account at a predetermined time.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 shows a diagram of a social donation system according to an embodiment of the present invention.

FIG. 2 shows a method of identifying and logging a donation according to an embodiment of the present invention.

FIG. 3 shows a method of identifying and logging a donation with donation condition according to an embodiment of the present invention.

FIG. 4 shows a method of transferring funds according to an embodiment of the present invention.

### DETAILED DESCRIPTION

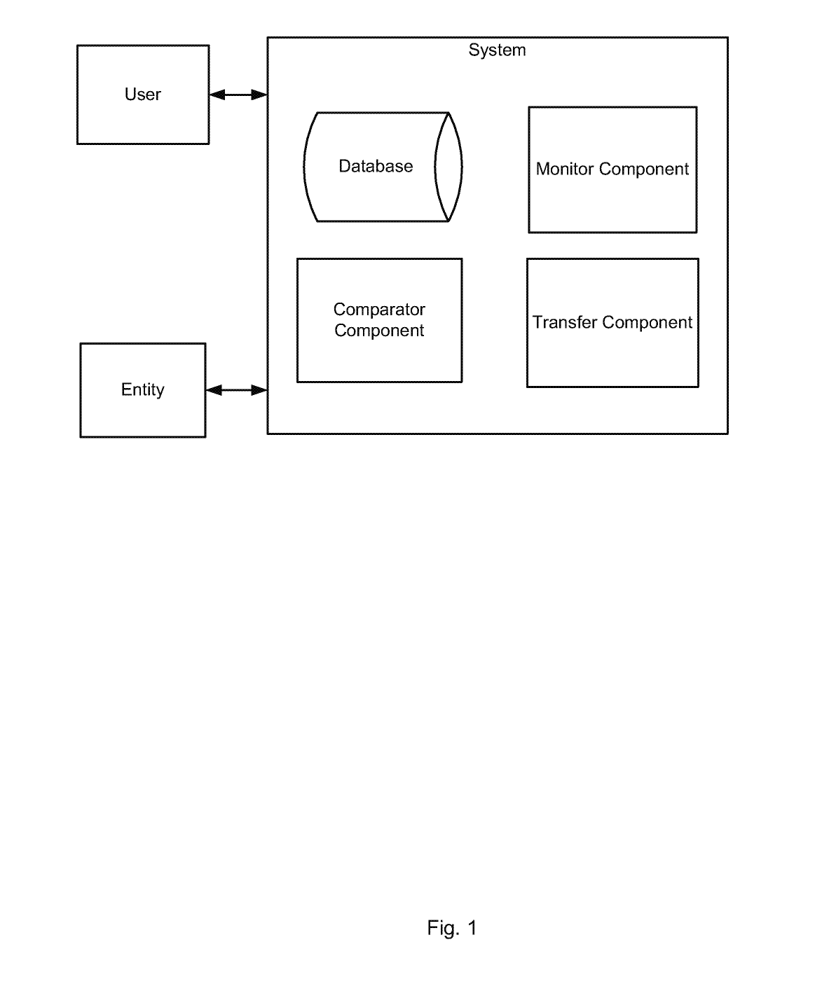

Referring now to the drawings, wherein like reference numerals refer to like parts throughout, there is seen in FIG. 1, a diagram of a social donation system according to an embodiment of the present invention.

According to an embodiment, the present invention comprises a system and a method for allowing a user of to transfer funds (donate) to various entities via actions on a social networking site. Broadly, the user may configure the system to identify certain actions on social networking site, such as clicking a “like” button, to represent a command to transfer funds to an entity. Upon identifying the action, the system may transfer funds from the user to the entity. Here, social networking includes any site, accessed via a browser or other application, which allows social interaction between two or more users. Some well-known social networking sites include Facebook, Google+, LinkedIn, Twitter or Myspace. However, a person skilled in the art will recognize that this list is not exclusive and includes any other current or future sites that allow social interaction between users. Further, a social network may include a site with social network plug-ins, such as the Facebook “like” button that may be added to third-party websites. An entity may include any natural person, foundation or organization such as a corporation, non-profit, or not-for-profit corporation. The entity may include charitable organizations, and other organizations not for charity.

According to one embodiment, the system may comprise a database for storing about users and entities participating in the social donation system, a monitoring component for identifying a predetermined action on a social network, and a transfer component for transferring funds from a user to an entity. In an alternative embodiment, the system may also comprise a comparator component for checking a donation condition. The system may exist on either the user's computer, on a server, or distributed between a client and server. For example, the system may be implemented as plug-in to a browser that could monitor the social network activity of a user conducted on the browser. In an alternative embodiment, the system could run as a third-party social networking application which the user could implement on his or her social networking profile. In another embodiment, the system may be implemented by the social network itself, running on the social network's servers. The system may also be distributed in part on a client and in part on a server. For example, the monitoring component may exist on the client end and the database and transferring component may exist on the server end, or any other possible distribution. Furthermore, each component may itself be distributed between a server and a client, or across multiple servers and multiple clients.

The system, according to one embodiment may receive and store, in the database, user information in order to facilitate quick and easy transfers upon a single donation action. The information stored may comprise, but is not limited to, contact information, such as the user's name, e-mail address, phone number, and payment information such as bank account information, credit card or debit card information. The system may also store the particular action or actions that triggers a donation (hereinafter a “donation action”), and the size of the donation per action. The database may also store user preferences, a donation condition, and a time, date, or interval to deduct all total donations from the user's payment account for a period of time. A user may input this information into the database during a preliminary set-up, or it may be configured to contain default stored information that may be altered by a user at any time.

The system may also receive and store an entity's information to allow efficient transfers. In the preferred embodiment the system will store information contact information for the entity, as well as a payment account so the entity may receive funds. The system may also store information about the entity such as, the kind of work it accomplishes, whether it is for profit or not-for-profit, whether it is a charitable organization, etc. The system may also store information about a time, date, or interval to disburse the total donations over a period of time into the entity's payment account.

The stored donation action could be any mechanism for social interaction between a user and an entity on the social networking site. For example, the action could be the user participates in a voting feature, such as “liking” an entity's post or page on Facebook, selecting +1 on Google Plus, or upvoting on Reddit. Similarly, the action could be to identify the user replying to a particular entity, such as replying to an entity's comment, posting on the entity's page, joining an entities “group,” or replying, or accepting an invitation to an entity's event, or “tweeting” to a particular hashtag that is associated with an entity on Twitter. The stored action could also be anytime the user shares something on a social networking page, such as by “sharing” on Linkedln, or “retweeting” an entity's “tweet” on Twitter. A person skilled in the art will recognize that this list is not exclusive, and the system may be configured to be triggered by any mechanism for social interaction between a user and an entity on a social networking site.

Alternatively, the donation may be an action by the entity rather than the user. The user may configure the system to transfer funds to any entity engaging in a pre-determined action. For example, the user may configure the system to donate to any entity tweeting with a particular hashtag, or joining a particular, or accepting an invite to an event. The system could be configured by the user to recognize any entity's social networking action as a donation action.

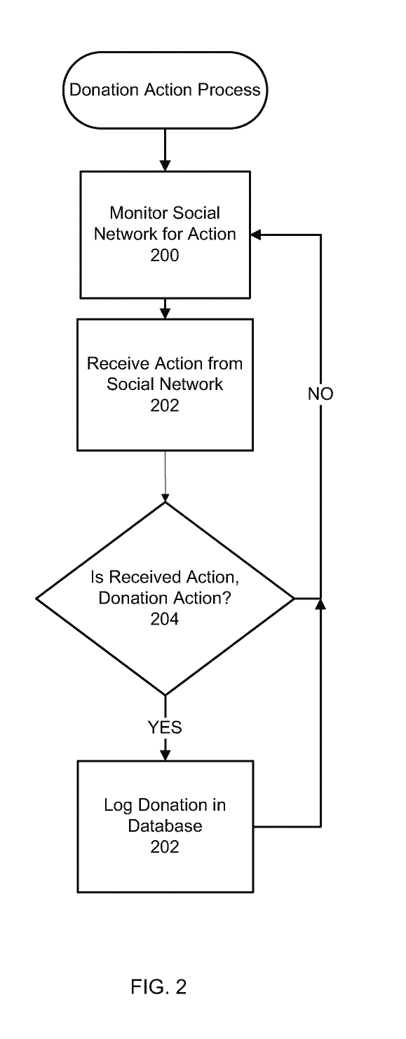

FIG. 2 shows a method for identifying and logging a donation. In step 200, the monitoring component monitors the social network for an action. The act of monitoring may comprise actively monitoring the social network, or passively waiting to receive an action. Further, the monitoring component may only monitor that portion of the social network necessary to identify the donation action. For example, if the donation action is a user “liking” an entity's profile, the monitoring component may only monitor the user's activity. In step 202, the monitoring component receives an action on the social network. In step 204, the monitoring component compares the received action to the stored action to determine whether the received action constitutes a donation action. This step may further comprise the steps of retrieving from the database, or otherwise retrieving from memory, the stored donation action and comparing the retrieved donation action to the received action. If the received action matches the stored donation action, the monitoring component logs the donation at step 206 and jumps back to step 200 to continue monitoring for another action. The donation may be logged in the database and associated with the user. If the received action does not match the stored donation action, the monitoring component jumps immediately to step 200.

The user may also configure the system to contain a donation condition that would prevent the system from transferring funds if the condition has not been met. The donation condition may be any conditional statement selected by a user. In one embodiment, a donation condition may limit the donation actions to actions an entity has marked as specifically requesting donations. Another donation condition may only allow donations to certain kinds of charities, such as charities that are dedicated to finding cures for a disease, or charities dedicated to helping disaster victims. Another donation condition may set a maximum donation limit within a certain time period. For example, the user may configure the system to donate $1 any time he or she “likes” a charity dedicated to finding a cure for cancer, with a maximum donation of $30 per month. If the user configures the system with these conditions, and selects “likes” an entity on Facebook that, for example, raises money for autism research, the system will not donate to the charity, because the entity does not meet the proper type of charity to meet the donation condition. Similarly, if the user “likes” an entity on Facebook that raises money for cancer, but has already donated $30 that month, the system will not transfer to the charity because the maximum donation limit has been exceeded.

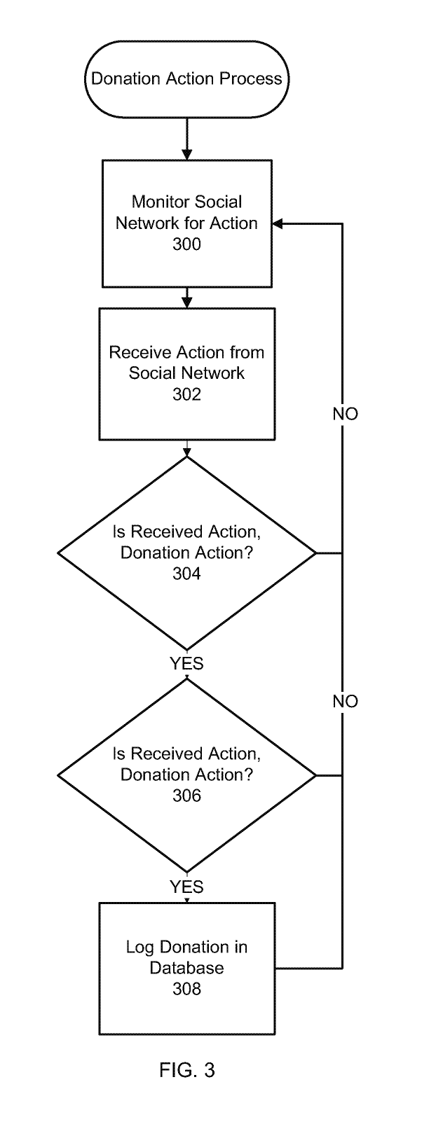

FIG. 3 illustrates the same method shown in FIG. 2, with the added steps of checking a donation condition. If, in step 304, the monitoring component identifies a donation action, a comparator component will check, in step 306, to see if a stored donation condition has been met. Step 306 may comprise the step of retrieving from the database, or otherwise from memory, the stored donation condition, and retrieving the information necessary to determine whether the stored donation condition has been met. Then, the comparator module will compare the donation condition against the relevant data to see if the condition has been met. If the condition has been met, the comparator module will continue to step 308, to log the donation in the database, or will otherwise pass the data off to be stored. For example, if the stored donation condition is a monthly maximum donation limit of $30, the comparator component may retrieve the data identifying that donation condition, as well the total user's donations in the current month. Next, the comparator module will compare the month's total donation against the monthly maximum. If allowing the donation to continue would cause the monthly total to exceed the maximum, then condition has not been met, and the comparator module will prevent the donation from being logged and the system will jump to step 300. If the allowing the donation to continue would not cause the monthly total to exceed the maximum, the comparator module will continue to step 308.

The system, according to one embodiment, may store in the database a time, date, or interval to deduct all total donations from the user's payment account for a period of time. The user may determine this period of time. For example, the user may set a donation period of one month, wherein, at the end of the month, the system would calculate and transfer the total donations to each charity over the course of the month. Alternatively, the user could set the system to deduct the donation from user's account the moment the donation action is selected. In another embodiment, the user could set a donation delay, causing the system to wait a set period of time after the donation action before charging the account. In yet another embodiment, the user may configure the system to transfer to the funds at a command.

Similarly, the entity may store in the database a time, date, or interval to disburse the total donations over a period of time into the entity's payment account. For example, the entity may store a preference to receive all disbursements for a particular month at particular date or date, or at the entities command. The entity may elect to have disbursements occur at the entity's manual request, at a future date requested by the entity, or at regular intervals determined by the entity. Alternatively, the system may deduct the funds and transfer them immediately to the stored account of the entity, without the use of an escrow account.

Upon completion of the charge, the user may be notified of the charge with a receipt via e-mail, text message, or any other notification method selected by the user. Alternatively, the system could be configured to notify the user of all charges over a predetermined period of time, such as weekly, bi-weekly, or monthly. The user may also configure the system to publish the user's donations on a particular social networking platform. For example, the user could configure the system to publish to the user's Facebook “wall,” a list of all of the user's donations over the course of a week.

Upon the completion of the donation, or the donation action, the system may associate the user's profile with the entity. Whereupon, the entity could view all a list of all associated users that had donated to it, and the user could view a list of entities he or she had donated to.

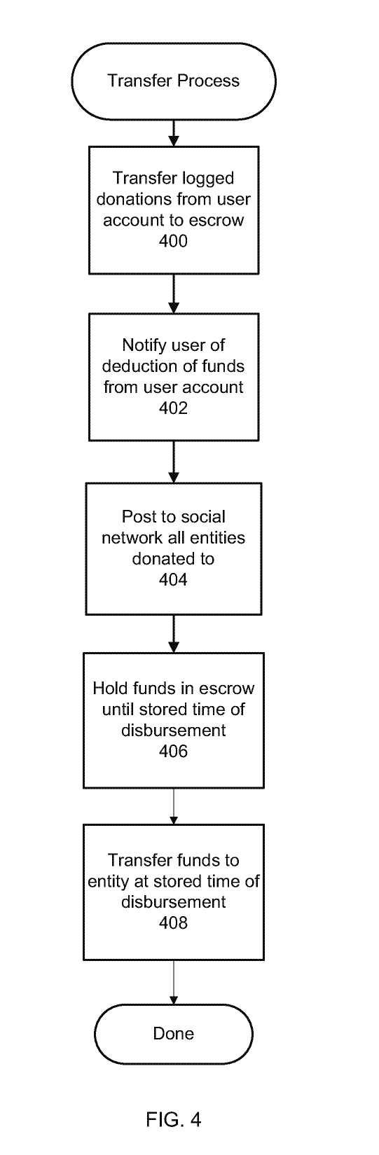

FIG. 4 illustrates the method for deducting funds from a user account and transferring them to the entity's payment account. In step 400, at the time stored in the database, or otherwise at a command, or at the time of donation, the system transfers the logged donations from the user's stored payment account to an escrow account. In one embodiment, at step 402, the user is notified of the deduction of funds from his or her payment account. In an alternative embodiment, at step 404, a list of all entities the user has donated to is posted on a social network of the user's choosing. At step 406, the funds are held in the escrow account until the stored time of disbursement occurs. Once the stored time of disbursement occurs, at step 408, the funds are transferred to the entity, completing the process.

In an alternative embodiment, a user could pay a sum of money to an escrow account, and deduct funds directly from that account as the user selects the donation actions, until that account is depleted.

As will be appreciated by one skilled in the art, aspects of the present invention may be embodied as a system, method or computer program product. Accordingly, aspects of the present invention may take the form of an entirely hardware embodiment, an entirely software embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present invention has been described in connection with a preferred embodiment, it should be understood that modifications, alterations, and additions can be made to the invention without departing from the scope of the invention as defined by the claims.

What is claimed is:

1. A method of transferring funds to an entity, comprising the steps of:
identifying an action on a social networking site, predetermined to represent a command to transfer funds to an entity;
retrieving previously stored information identifying at least one payment account associated with said user;
retrieving previously stored information identifying at least one payment account associated with said entity; and
transferring said funds from said payment associated with said user to said payment account associated with said entity.

2. The method of claim 1, further comprising the step of retrieving previously stored information identifying the amount of funds to be transferred upon identifying said user action.

3. The method of claim 1, wherein said action is performed by said user.

4. The method of claim 1, wherein said action is performed by said entity.

5. The method of claim 1, further comprising the steps of:
retrieving previously stored data identifying a donation condition;
checking whether said donation conditions has been met;
preventing said transfer if said donation condition has not been met.

6. The method of claim 9, wherein said donation condition is a maximum donation limit within a predetermined period of time.

7. The method of claim 9, wherein said donation condition is a type of entity.

8. The method of claim 1, further comprising the step of posting to a predetermined social network the entities to which said user has donated.

9. The method of claim 1, wherein the step of transferring comprises
deducting said funds from said payment account;
depositing said funds into an escrow account;
deducting said funds from said escrow account; and
depositing said funds into said payment account associated with said entity.

10. The method of claim 11, wherein the step of deducting funds from said user's payment account occurs at a predetermined time.

11. The method of claim 11, wherein the step of transferring to said entity occurs at a predetermined time.

12. A server system for transferring funds to an entity, comprising:
a data storage medium storing data for at least one user and at least one entity;
a monitoring component for identifying at least one action on a social networking site, predetermined to represent a command to transfer funds to said at least one entity;
a transferring component that, upon identifying said user action, retrieves from the data storage medium data representing a payment account associated with said user, and
data representing a payment account associated with said entity, and that transfers funds from said user's payment account to said entity's payment account.

13. The system of claim 12, wherein the transferring component retrieves the amount to be transferred from said data storage medium.

14. The system of claim 12, wherein the action is performed by said user.

15. The system of claim 12, wherein the action is performed by said entity.

16. The system of claim 15, further comprising:
a comparator component that retrieves from the data storage medium data representing a donation condition, that checks whether said donation condition has been met, and that prevents the transfer of funds if said condition has not been met.

17. The system of claim 16, wherein said donation condition is a maximum donation limit within a predetermined period of time.

18. The system of claim 16, wherein said donation condition is a type of entity.

19. The system of claim 14, further comprising a posting component for posting to a predetermined social network the entities to which said user has donated.

20. The system of claim 18, wherein the transferring component first transfers said funds to an escrow account and then transfers said funds to said entity.

21. The system of claim 18, wherein the transferring component transfers said funds from said user's payment account to said escrow at a predetermined time.

22. The system of claim 18, wherein the transferring component transfers said funds from said escrow account at a predetermined time.
